(19) United States
(12) Patent Application Publication
(10) Pub. No.: US 2024/0342807 A1
(43) Pub. Date: Oct. 17, 2024

(54) Drill Bit Depth Gauge Indicator Device

(71) Applicant: Gerald Lewis, Shreline, WA (US)

(72) Inventor: Gerald Lewis, Shreline, WA (US)

(21) Appl. No.: 18/628,875

(22) Filed: Apr. 8, 2024

Related U.S. Application Data
(60) Provisional application No. 63/496,480, filed on Apr. 17, 2023.

(51) Int. Cl. B23B 51/00

(52) U.S. Cl. CPC B23B 51/0095; B23B 2260/0487

(57) ABSTRACT

A drill bit depth gauge device is disclosed that will inform a user of how deep he/she has drilled into a surface. The drill bit depth gauge device comprises a shaft with a plurality of depth measurement markings to indicate how deep the drilling has gone into the surface. The device will make sure drill bits are not damaged and will last longer, while also preventing the operator from drilling too far into materials and causing damage. Further, the drill bit depth gauge device is available in different sizes and configurations to accommodate a variety of different drilling needs.

### CROSS-REFERENCE TO RELATED APPLICATION

The present application claims priority to, and the benefit of, U.S. Provisional Application No. 63/496,480, which was filed on Apr. 17, 2023, and is incorporated herein by reference in its entirety.

### FIELD OF THE INVENTION

The present invention relates generally to the field of drill bit depth gauge devices. More specifically, the present invention relates to an improved drill bit that informs operators of how deep they have drilled into a surface. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in drill bit depth gauge devices. Generally, when using drill bits to drill through materials, people may be unaware of how deep they are drilling through the material. Even experienced people may have trouble identifying the depth at which the drill bit is located within the material they are drilling. Further, damage can occur to electrical wires, plumbing drains, water sources, etc., if a drill is pushed too far into the material.

In the drilling field, and with other types of drilling operations, it is often necessary to drill a hole of a particular depth in a surface. However, with conventional drill bits, the judgment of the depth to which a drill bit has penetrated a surface, and therefore the depth of the hole generated, is a matter of guesswork. Further, if a hole has been drilled too short, then one can drill further with a second attempt, but if the hole has been drilled too deep, it is difficult or impossible to rectify.

Attempts have been made in the past to provide gauges for measuring the extent of penetration of a drill bit but these have been rather cumbersome devices. Alternatively, some people have made temporary depth gauges upon the drill bits themselves by securing pieces of tape at intervals along the drill bit. These may provide a crude indication of the depth of penetration but can easily be dislodged by the drilling action itself, leading to inaccuracy or the risk of damage to the drill.

Accordingly, there is a demand for an improved drill bit depth gauge device that can inform a user of how deep they have drilled into a surface. More particularly, there is a demand for a drill bit depth gauge device that ensures that bits are not damaged and will last longer.

Therefore, there exists a long-felt need in the art for a drill bit depth gauge device that provides users with an improved drill bit that informs operators of how deep they have drilled into a surface. There is also a long-felt need in the art for a drill bit depth gauge device that includes multiple depth measurements on the drill bit gauge that can quickly visualize how deep the gauge is in the material while drilling. Further, there is a long-felt need in the art for a drill bit depth gauge device that features several sizes and configurations of drill bits that can be used in different situations. Moreover, there is a long-felt need in the art for a device that saves considerable time and effort when drilling to prevent damage to material and any wires, plumbing lines, etc., that may be embedded within the material. Further, there is a long-felt need in the art for a drill bit depth gauge device that makes sure drill bits are not damaged and will last longer. Finally, there is a long-felt need in the art for a drill bit depth gauge device that is available in different sizes and configurations to accommodate various drilling needs.

The subject matter disclosed and claimed herein, in one embodiment thereof, comprises a drill bit depth gauge device. The device will inform a user of how deep he/she has drilled into a surface with a special gauge. The drill bit depth gauge device comprises a shaft with a plurality of depth measurement markings to indicate how deep the drilling has gone into the surface. The device will make sure drill bits are not damaged and will last longer, while also preventing the operator from drilling too far into materials and causing damage. Further, the drill bit depth gauge device is available in different sizes and configurations to accommodate a variety of different drilling needs.

In this manner, the drill bit depth gauge device of the present invention accomplishes all of the foregoing objectives and provides users with a device that informs operators of how deep they have drilled into a surface. The device comprises several different drill bits available in different sizes and configurations. The device can be manufactured of a metal material.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a drill bit depth gauge device. The device will inform a user of how deep he/she has drilled into a surface. The drill bit depth gauge device comprises a drill bit shaft with a plurality of depth measurement markings to indicate how deep the drilling has gone into the surface. The device will make sure drill bits are not damaged and will last longer, while also preventing the operator from drilling too far into materials and causing damage.

In one embodiment, the drill bit depth gauge device is utilized with a conventional drill, such as a masonry drill, an orthopedic drill, a metal drill, a wood drill, etc., or any other suitable drill as is known in the art. The drill and drill bit depth gauge device includes a drill bit, a chuck, and a handle. In one embodiment, the drill bit depth gauge device is used with a masonry drill bit, a metal drill bit, a wood drill bit, etc., but may be any other suitable type of drill bit as is known in the art.

In one embodiment, the handle provides control of the drill and may help in achieving a desired direction for a hole. Specifically, the handle is used to position the drill bit against the surface in which a hole is to be made. The handle also allows the user to orientate the drill bit to correspond to the direction of the desired hole.

In one embodiment, the drill bit comprises a shaft. The shaft is circular in cross-section with a diameter in the range of 2.7 mm to 6.5 mm. Its length can range from 40 to 160 mm. Externally, the drill bit can be made to have the same appearance as any standardized drill bit.

In one embodiment, the end of the shaft provides an attachment point to facilitate securing the drill bit to the chuck of the drill. Further, the opposite end of the shaft provides a cutting region. The cutting region typically has 2-4 spiral-shaped cutting edges that extend along the length of the shaft. The cutting region's diameter is similar to that of the shaft, while its length can vary from 40 mm to 60 mm depending on the intended use of the drill bit. In another embodiment, the cutting region of the shaft comprises a butterfly bit, such that it comprises a flat portion and a beveled cutting feature.

In one embodiment, the drill bit depth gauge device comprises a drill bit comprising a shaft having permanently applied depth markings at one or more positions along its surface. The permanently applied depth markings are most preferably formed by one or more radial grooves cut into the surface of the drill bit shaft.

In one embodiment, preferably, two or more grooves are provided, spaced apart by predetermined distances, along the surface of the drill bit shaft and these may be, for example, at intervals of one inch, two inches, one centimeter, two centimeters or any other suitable distance apart as is known in the art, depending on the needs and/or wants of a user.

In one embodiment, there are three grooves provided along the shaft, spaced apart, on the drill bit. However, any suitable number of grooves can be utilized as is known in the art, depending on the needs and/or wants of a user.

In one embodiment, the grooves may be formed in any suitable manner as is known in the art, such as cutting grooves in the shaft surface, by laser etching, by machining, or by other suitable means as is known in the art.

In one embodiment, instead of grooves, other permanent markings may be applied, such as by the use of color coding, (i.e., permanent inks which are applied to the surface of the drill bit shaft). Alternatively, permanently affixed bands may be applied to the surface of the drill bit shaft, (i.e., of a contrasting type or color metal to the metal of the drill bit shaft) and can be soldered, welded, or otherwise permanently applied to the drill bit shaft.

In operation, the drill bit of the device is secured within a conventional drill via a drill chuck in a known manner. The drill is then engaged, which causes the drill bit to rotate. The user applies pressure to the drill bit, thereby causing the cutting edges to form a hole in the surface. This continues until the user determines that a hole of sufficient depth has been made, based on depth markings on the shaft. Specifically, the drill bit is applied to a surface, such that when the first of the grooves reaches the surface itself, the user knows for certain that the drill bit has penetrated to a certain predetermined depth. If this depth is not sufficient, then the user may continue applying the drill bit until the second groove has been reached, and so forth, until the desired depth has been reached, as needed.

Furthermore, it will be appreciated that the dimensions and the proportions of the drill bit depth gauge device may be varied as necessary to suit particular applications. Thus, the drill bit depth gauge device may be available in different sizes and configurations to accommodate all drilling needs.

In one embodiment, the drill bit depth gauge device is manufactured of a metal or metal material, such as steel, carbide, tool steel, bi-carbon steel, etc., or any other suitable materials and/or combinations thereof as is known in the art.

In yet another embodiment, the drill bit depth gauge device comprises a plurality of indicia.

In yet another embodiment, a method of informing a user of how deep they have drilled into a surface is disclosed. The method includes the steps of providing a drill bit depth gauge device comprising a drill bit shaft with a plurality of depth measurement markings to indicate how deep the drilling has gone into the surface. The method also comprises inserting the drill bit depth gauge device into a standard drill chuck and securing it. Further, the method comprises inserting the drill bit depth gauge device onto a surface wanting to be drilled. The method also comprises utilizing the drill bit depth gauge device as a conventional drill bit and drilling a hole in the surface. Finally, the method comprises identifying the depth of the hole as a user is drilling via the measurements on the drill bit shaft.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the drill bit depth gauge device of the present invention showing several different drill bits available in different sizes and configurations in accordance with the disclosed architecture;

FIG. 2 illustrates a front perspective view of one embodiment of the drill bit depth gauge device of the present invention showing the drill bit and the depth gauge measurements in accordance with the disclosed architecture;

FIG. 3 illustrates a perspective view of one embodiment of the drill bit depth gauge device of the present invention showing a user drilling into material with the drill bit in accordance with the disclosed architecture;

FIG. 4 illustrates a perspective view of one embodiment of the drill bit depth gauge device of the present invention showing the device in use in accordance with the disclosed architecture;

FIG. 5 illustrates a perspective view of one embodiment of the drill bit depth gauge device of the present invention showing how depth can be easily identified via the measurements on the drill bit in accordance with the disclosed architecture; and

FIG. 6 illustrates a flowchart showing the method of informing a user of how deep they have drilled into a surface in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a drill bit depth gauge device that provides users with an improved drill bit that informs operators of how deep they have drilled into a surface. There is also a long-felt need in the art for a drill bit depth gauge device that includes multiple depth measurements on the drill bit gauge that can quickly visualize how deep the gauge is in the material while drilling. Further, there is a long-felt need in the art for a drill bit depth gauge device that features several sizes and configurations of drill bits that can be used in different situations. Moreover, there is a long-felt need in the art for a device that saves considerable time and effort when drilling to prevent damage to material and any wires, plumbing lines, etc., that may be embedded within the material. Further, there is a long-felt need in the art for a drill bit depth gauge device that makes sure drill bits are not damaged and will last longer. Finally, there is a long-felt need in the art for a drill bit depth gauge device that is available in different sizes and configurations to accommodate various drilling needs.

The present invention, in one exemplary embodiment, is a novel drill bit depth gauge device. The device will inform a user of how deep he/she has drilled into a surface. The drill bit depth gauge device comprises a shaft with a plurality of depth measurement markings to indicate how deep the drilling has gone into the surface. The device will make sure drill bits are not damaged and will last longer, while also preventing the operator from drilling too far into materials and causing damage. Further, the drill bit depth gauge device is available in different sizes and configurations to accommodate a variety of different drilling needs. The present invention also includes a novel method of informing a user of how deep they have drilled into a surface. The method includes the steps of providing a drill bit depth gauge device comprising a drill bit shaft with a plurality of depth measurement markings to indicate how deep the drilling has gone into the surface. The method also comprises inserting the drill bit depth gauge device into a standard drill chuck and securing it. Further, the method comprises inserting the drill bit depth gauge device onto a surface wanting to be drilled. The method also comprises utilizing the drill bit depth gauge device as a conventional drill bit and drilling a hole in the surface. Finally, the method comprises identifying the depth of the hole as a user is drilling via the measurements on the drill bit shaft.

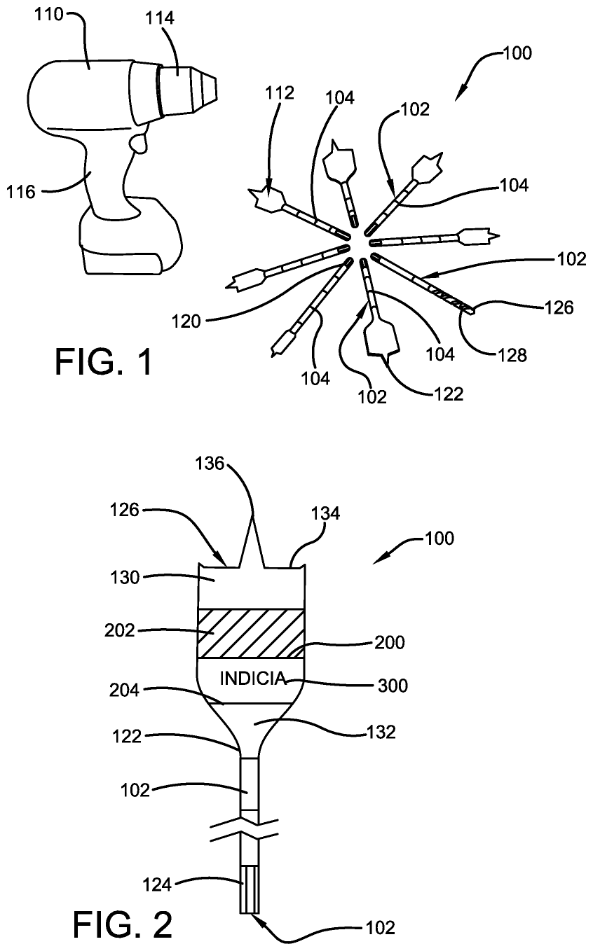

Referring initially to the drawings, FIG. 1 illustrates a perspective view of one embodiment of the drill bit depth gauge device 100 of the present invention. In the present embodiment, the drill bit depth gauge device 100 is an improved drill bit depth gauge device 100 that provides a user 108 with an improved drill bit that informs users of how deep they have drilled into a surface 106. Specifically, the drill bit depth gauge device 100 comprises a drill bit shaft 102 with a plurality of depth measurement markings 104 to indicate how deep the drilling has gone into the surface 106. The device 100 will make sure drill bits are not damaged and will last longer, while also preventing the operator 108 from drilling too far into materials and causing damage.

Generally, the drill bit depth gauge device 100 is utilized with a conventional drill 110, such as a masonry drill, an orthopedic drill, a metal drill, a wood drill, etc., or any other suitable drill as is known in the art. The drill 110 and drill bit depth gauge device 100 includes a drill bit 112, a chuck 114, and a handle 116. In one embodiment, the drill bit depth gauge device 100 is used with a masonry drill bit, a metal drill bit, a wood drill bit, etc., but may be any other suitable type of drill bit 112 as is known in the art.

Overall, the handle 116 provides control of the drill 110 and may help in achieving the desired direction for a hole. Specifically, the handle 116 is used to position the drill bit 112 against the surface 106 in which a hole 118 is to be made. The handle 116 also allows the user 108 to orientate the drill bit 112 to correspond to the direction of the desired hole 118. The handle 116 can be any suitable shape and size as is known in the art, as long as it's shaped to ergonomically allow a user to comfortably hold and use the drill 110.

Furthermore, the drill bit 112 comprises a shaft 102. The shaft 102 is circular in cross-section with a diameter in the range of 2.7 mm to 6.5 mm. Its length can range from 40 to 160 mm. Externally, the drill bit 112 can be made to have the same appearance as any standardized drill bit.

Generally, the shaft 102 comprises a first-end 120, and an opposing second-end 122. The first end 120 of the shaft 102 provides an attachment point 124 to facilitate securing the drill bit 112 to the chuck 114 of the drill 110. Further, the opposite end (i.e., second end 122) of the shaft 102 provides a cutting region 126. The cutting region 126 typically has 2-4 spiral-shaped cutting edges 128 that extend along the length of the shaft 102. The cutting region's diameter is similar to that of the shaft 102, while its length can vary from 40 mm to 60 mm depending on the intended use of the drill bit 112. In another embodiment, the cutting region 126 of the shaft 102 comprises a butterfly bit 130, such that it comprises a flat portion and a beveled cutting feature, or any combination thereof.

Furthermore, it will be appreciated that the dimensions and the proportions of the drill bit depth gauge device 100 may be varied as necessary to suit particular applications. Thus, the drill bit depth gauge device 100 may be available in different sizes and configurations to accommodate all drilling needs.

As shown in FIG. 2, the drill bit depth gauge device 100 comprises a drill bit 112 comprising a shaft 102 having permanently applied depth markings 104 at one or more positions along its surface 132. The permanently applied depth markings 104 are most preferably formed by one or more radial grooves 200 cut into the surface of the drill bit shaft 102. In one embodiment, preferably, two or more grooves 200 are provided, spaced apart by predetermined distances, along the surface 132 of the drill bit shaft 102 and these may be, for example, at intervals of one inch, two inches, one centimeter, two centimeters or any other suitable distance apart as is known in the art, depending on the needs and/or wants of a user 108. In another embodiment, there are three grooves 200 provided along the shaft 102, spaced apart, on the drill bit 112. However, any suitable number of grooves 200 can be utilized as is known in the art, depending on the needs and/or wants of a user 108.

Generally, the grooves 200 may be formed in any suitable manner as is known in the art, such as cutting grooves 200 in the shaft 102 surface 132, by laser etching, by machining, or by other suitable means as is known in the art.

Additionally, instead of grooves 200, other permanent markings 104 may be applied, such as by the use of color coding 202, (i.e., permanent inks which are applied to the surface 132 of the drill bit shaft 102). Alternatively, permanently affixed bands 204 may be applied to the surface 132 of the drill bit shaft 102, (i.e., of a contrasting type or color metal to the metal of the drill bit shaft 102) and which can be soldered, welded, or otherwise permanently applied to the drill bit shaft 102.

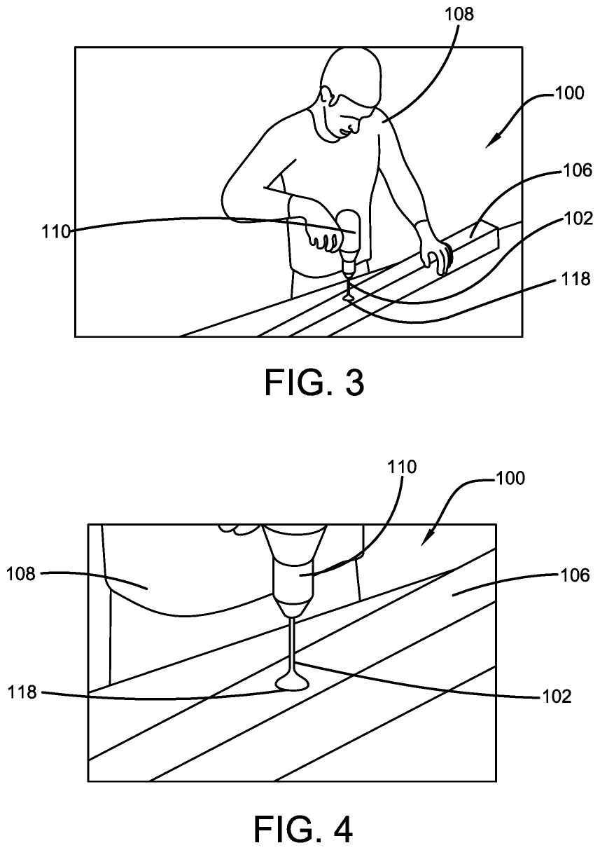

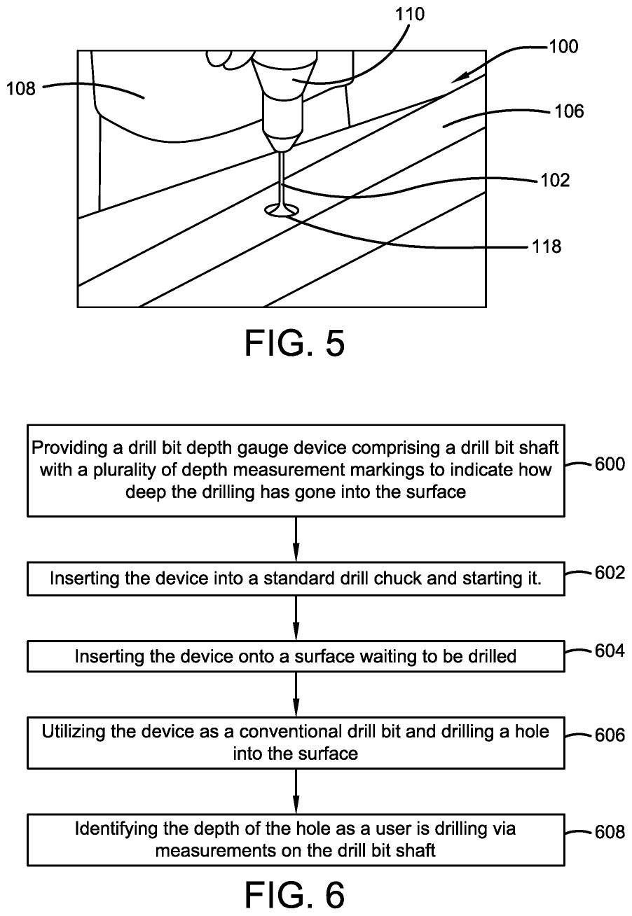

As shown in FIGS. 3-5, in operation, the drill bit 112 of the device 100 is secured within a conventional drill 110 via a drill chuck 114 in a known manner. The drill 110 is then engaged, which causes the drill bit 112 to rotate. The user 108 applies pressure to the drill bit 112, thereby causing the cutting edges 128 to form a hole 118 in the surface 106. This continues until the user 108 determines that a hole 118 of sufficient depth has been made, based on depth markings 104 on the shaft 102 of the drill bit 112. Specifically, the drill bit 112 is applied to a surface 106, such that when the first of the grooves 200 reaches the surface 106 itself, the user 108 knows for certain that the drill bit 112 has penetrated to a certain predetermined depth. If this depth is not sufficient, then the user 108 may continue applying the drill bit 112 until the second groove 200 has been reached, and so forth, until the desired depth has been reached, as needed.

Generally, the drill bit depth gauge device 100 is manufactured of a metal or metal material, such as steel, carbide, tool steel, bi-carbon steel, etc., or any other suitable materials and/or combinations thereof as is known in the art.

In yet another embodiment, the drill bit depth gauge device 100 comprises a plurality of indicia 300. The shaft 102 of the device 100 may include advertising, a trademark, or other letters, designs, or characters, printed, painted, stamped, or integrated into the shaft 102, or any other indicia 300 as is known in the art. Specifically, any suitable indicia 300 as is known in the art can be included, such as, but not limited to, patterns, logos, emblems, images, symbols, designs, letters, words, characters, animals, advertisements, brands, etc., that may or may not be drill, drill bit, or brand related.

FIG. 6 illustrates a flowchart of the method of informing a user of how deep they have drilled into a surface. The method includes the steps of at 600, providing a drill bit depth gauge device comprising a drill bit shaft with a plurality of depth measurement markings to indicate how deep the drilling has gone into the surface. The method also comprises at 602, inserting the drill bit depth gauge device into a standard drill chuck and securing it. Further, the method comprises at 604, inserting the drill bit depth gauge device onto a surface wanting to be drilled. The method also comprises at 606, utilizing the drill bit depth gauge device as a conventional drill bit and drilling a hole in the surface. Finally, the method comprises at 608, identifying the depth of the drill bit depth gauge device as a user is drilling via the measurements on the drill bit.

Certain terms are used throughout the following description and claims to refer to particular features or components. As one skilled in the art will appreciate, different users, may refer to the same feature or component by different names. This document does not intend to distinguish between components or features that differ in name but not structure or function. As used herein “drill bit depth gauge device”, “drill bit device”, “depth gauge device”, and “device” are interchangeable and refer to the drill bit depth gauge device 100 of the present invention.

Notwithstanding the foregoing, the drill bit depth gauge device 100 of the present invention can be of any suitable size and configuration as is known in the art without affecting the overall concept of the invention, provided that it accomplishes the above-stated objectives. One of ordinary skill in the art will appreciate that the drill bit depth gauge device 100 as shown in FIGS. 1-6 is for illustrative purposes only, and many other sizes and shapes of the drill bit depth gauge device 100 are well within the scope of the present disclosure. Although the dimensions of the drill bit depth gauge device 100 are important design parameters for user convenience, the drill bit depth gauge device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drill bit depth gauge device that provides a user with a drill bit that informs users of how deep they have drilled into a surface, the drill bit depth gauge device comprising:
a drill bit shaft; and
a plurality of depth measurement markings; and
wherein the plurality of depth measurement markings are positioned on the drill bit shaft to indicate how deep a user has drilled into a surface; and
further wherein the drill bit shaft is utilized with a conventional drill.

2. The drill bit depth gauge device of claim 1, wherein the conventional drill includes a drill chuck and a handle.

3. The drill bit depth gauge device of claim 2, wherein the handle is used to position the drill bit shaft against the surface in which a hole is to be made.

4. The drill bit depth gauge device of claim 3, wherein the drill bit shaft is circular in cross section and comprises a first end and an opposing second end.

5. The drill bit depth gauge device of claim 4, wherein the first end provides an attachment point to facilitate securing the drill bit shaft to the drill chuck of the conventional drill.

6. The drill bit depth gauge device of claim 5, wherein the second end provides a cutting region.

7. The drill bit depth gauge device of claim 6, wherein the cutting region has 2-4 spiral shaped cutting edges that extend along a length of the drill bit shaft.

8. The drill bit depth gauge device of claim 6, wherein the cutting region comprises a butterfly bit with a flat portion and a beveled cutting feature.

9. The drill bit depth gauge device of claim 1, wherein the plurality of depth measurement markings are at least one radial groove, cut into a surface of the drill bit shaft.

10. The drill bit depth gauge device of claim 9, wherein the at least one radial groove is spaced apart by a predetermined distance, along the surface of the drill bit shaft.

11. The drill bit depth gauge device of claim 10, wherein the predetermined distance is one inch, two inches, one centimeter, or two centimeters.

12. The drill bit depth gauge device of claim 11, wherein the at least one radial groove is formed by laser etching or by machining.

13. The drill bit depth gauge device of claim 12, wherein the plurality of depth measurement markings are color coded permanent inks which are applied to the surface of the drill bit shaft.

14. The drill bit depth gauge device of claim 12 wherein the plurality of depth measurement markings are permanently affixed bands applied to the surface of the drill bit shaft.

15. A drill bit depth gauge device that provides a user with a drill bit that informs users of how deep they have drilled into a surface, the drill bit depth gauge device comprising:
a drill bit shaft that is circular in cross section and comprises a first end and an opposing second end; and
a plurality of depth measurement markings; and
wherein the drill bit shaft is utilized with a conventional drill including a drill chuck and a handle, wherein the handle is used to position the drill bit shaft against a surface in which a hole is to be made;
wherein the first end provides an attachment point to facilitate securing the drill bit shaft to the drill chuck of the conventional drill;
wherein the second end provides a cutting region which includes a butterfly bit;
wherein the plurality of depth measurement markings are positioned on the drill bit shaft to indicate how deep a user has drilled into a surface;
wherein the plurality of depth measurement markings are at least one radial groove, cut into a surface of the drill bit shaft; and
further wherein the at least one radial groove is spaced apart by a predetermined distance, along the surface of the drill bit shaft, such that when the at least one radial groove reaches the surface, a user knows for certain that the drill bit shaft has penetrated to a certain predetermined depth.

16. The drill bit depth gauge device of claim 15 further comprising a plurality of indicia.

17. The drill bit depth gauge device of claim 15, wherein the predetermined distance is one inch, two inches, one centimeter, or two centimeters.

18. The drill bit depth gauge device of claim 15, wherein the at least one radial groove is formed by laser etching or by machining.

19. The drill bit depth gauge device of claim 15, wherein the plurality of depth measurement markings are color coded permanent inks which are applied to the surface of the drill bit shaft.

20. A method of informing a user of how deep they have drilled into a surface, the method comprising the following steps:
providing a drill bit depth gauge device comprising a drill bit shaft with a plurality of depth measurement markings to indicate how deep the drilling has gone into the surface;
inserting the drill bit depth gauge device into a standard drill chuck and securing it;
inserting the drill bit depth gauge device onto a surface wanting to be drilled;
utilizing the drill bit depth gauge device as a conventional drill bit and drilling a hole in the surface; and
identifying the depth of the hole as a user is drilling via the measurements on the drill bit shaft.
